(19) United States
(12) Patent Application Publication
(10) Pub. No.: US 2006/0182114 A1
(43) Pub. Date: Aug. 17, 2006

(54) Routing of health information files

(76) Inventors: Anuthep Benja-Athon, New York, NY (US); Theda Benja-Athon, Port Washington, NY (US)

Correspondence Address: ANUTHEP BENJA-ATHON;Pain Management, 210 E 36th St., New York, NY, 10016, US

(21) Appl. No.: 11/196,823

(22) Filed: Aug. 4, 2005

Related U.S. Application Data
(63) Continuation-in-part of application No. 11/150,878, filed on Jun. 13, 2005.
Application No. 11/150,878 is a continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. H04L 12/56

(52) U.S. Cl. 370/395.3

(57) ABSTRACT

A system of directing or routing millions of electronic files per unit time each of which comprises health information on a patient to specific sites within computers and servers in a network of computers and servers. The basic units for tagging or labeling each file for routing are patient, physician identification and time and date headers generated by a least one digital voice recorder and/or one computer.

This application is a continuation-in-part of application Ser. No. 11/150,878 entitled Physicians' optimal management of health information filed Jun. 13, 2005 which is a continuation-in-part of application Ser. No. 11/114,763 entitled A System of Influencing Health-Care Utilizations filed Apr. 27, 2005 which is a continuation-in-part of application Ser. No. 11/074,236 entitled the System of Management of Health-Care Resources filed Mar. 7, 2005 and Ser. No. 11/059,088 entitled the Consumers-Buyers-Physicians Health-Care filed Feb. 16, 2005 which are pending.

### FIELD OF INVENTION

Speeding accurate movements of electronic health information.

### BACKGROUND OF THE INVENTION

The present invention is the catalyst for the implementations of the foremost and best healthcare system in the history of medicine and healthcare embodied in the patent pendings infra.

This patent application and nine other patent pendings including application Ser. Nos. 11/150,878 and 11/114,763—details cited in Ser. Nos. 11/150,878 and 11/114,763—and one patent U.S. Pat. No. 6,132,218 granted to this physician applicant represent the applicants' continual quests to provide the optimal solution to the current health-care crisis.

The present invention is the health, medical and health-care information and data routing means for optimizing the applications of said patent pendings and patent. The present invention uniquely provides the fastest means for effectively and speedily implementing the solutions embodied in said applications and patent so that the best system of medicine and healthcare in the history of mankind are sooner had.

### SUMMARY OF THE INVENTION

Millions of files of patients' and physician's data will be generated each day using the methods and systems taught by said pending patent applications. The present invention provides a routing system to generate a smooth and orderly movements of said information or data files from the points at which said files are produced or created by patients and physicians to prevent the inundations of computers and servers.

A system provides the method of directing or routing millions of electronic files per unit time each of which comprises health information on a patient to certain sites within computers and servers in a network of computers and servers. The basic units of the routing system are a plurality of physicians relating to a patient, an identification of each physician, an identification of a patient, an authentication process of each physician's identification, an authentication process of each patient's identification, a file comprising health and medical information of each patient, time and date header, a digital voice recorder and a network of computers and servers. Said identification data are entered into a digital voice recorder or digital voice recorders, a computer or computers by said physician and patient wherein said identification headers are generated from said identifications. Said system is enhanced by millions of patients and physicians using immense quantity of said devices.

### DESCRIPTION OF THE PREFERRED EMBODIMENTS

The present invention provides the routing system in the vast network of digital voice recorders, computers and servers for immense health, medical and health-care information and data to be produced by the methods and processes taught in said pending patent applications wherein hundreds of millions of patients and physicians in diverse settings, places, and locations using hundreds of thousands of digital voice recorders and the like and millions of computers and a national and international network of computers and servers at diverse time and dates of years. Said routing system is implemented at or about the points of inceptions of said information or data. Thus, the present invention provides a routing system to generate a smooth and orderly movements of said information or data files from the points at which said files are produced or created by patients and physicians to prevent the inundations of computers and servers wherein said information and data converge at all time—247 basis.

The present invention provides the means for tagging each file of health, medical and health-care information or data produced or generated by any individual such as a patient using a computer or computers or a physician using a computer, computers, a digital voice recorder or recorders or any combination thereof. Said information or data in each file can be in voice or text format.

According to the claims of the present invention, the basic units of the routing system are a plurality of physicians relating to a patient, an identification of each physician, an identification of a patient, an authentication process of each physician's identification, an authentication process of each patient's identification, a file comprising health and medical information of each patient, time and date header, a digital voice recorder and a network of computers and servers. Said identification of each physician, as shown in earlier patent application is such as, but not limited to, a physician's first, middle and last names, date of birth, social security number or tax identifications and the like such as, but not limited to, federal tax identification. Said identification of each patient, as shown in earlier patent application is such as, but not limited to, said patient's first, middle and last names, date of birth, social security number. Said identification data are entered into a digital voice recorder or digital voice recorders, a computer or computers by said physician and patient wherein said identification headers are generated from said identifications. Said identification headers are transferred between digital voice recorders and computers.

In a setting wherein a patient generated or produced his or her own file of medical information or data, only said patient's identification header and time and date header are linked to said file.

In a more common setting, a physician's identification header and a patient's identification header are linked to said patient's file comprising said patient's health and medical information produced or generated by said physician.

However, in the most common setting, a patient will have as many and different files comprising different and diverse health and medical information or data—as each file is produced by different physicians seeing or treating one and same patient—to which a patient's identification header is attached but individual and different physicians' identification headers are attached to each relevant file. In other words, a patient is seen or treated by a plurality of physicians in a unit time who appropriately generated or produced a plurality of files all of which has a common patient's identification header but each of which has a unique relevant physician's identification header, and also different time and dates header.

Represented in an earlier pending patent application, a preferred embodiment of the present invention is represented as follows:

<A patient's first and last names, date of birth, social security number>Header1

<A physician's first and last names, date of birth, social security number>Header2

<Time and date>Header3

<Patient's drug allergy+data1>

<Patient's food allergy+data2>

<Patient's past medical history+data3>

<Patient's past surgical history+data4>

<Patient's chief complaint+data5>

<Patient's diagnosis+data6>

<Treatment+data7>

<Procedures+data8>

<Follow-up+data9>

Representing one of the preferred embodiments of the present invention, a file below said three headers—Header1-Header3—in previous paragraph comprises 9 lines of titles to which are linked a plurality of health and medical information or data on a patient filed by a physician or a patient according to the titles of the file as described supra and infra and also in an earlier pending patent application. In other words, said three headers linking to said file is the name, tag or label for said file and it is used by said computers in the network of computers to route or direct said file to certain sites or locations within computers and servers in the network of computers and servers. Therefore, on national and international scales, millions of unique names, tags or labels will be generated or produced for tagging, naming or labeling equal number of files per unit time by patients and/or physicians with the computerized performances by digital voice recorders, computers and servers.

Although said tagging, naming or labeling of said file represents only one of the preferred embodiments of this invention, it will be appreciated by those skilled in the art and computer science/programming that adaptations and variations to said method and system may be made without departing from the spirit of the invention and the scope of the claims in order to achieve of the goals and objectives of the present invention.

Furthermore, as an extension of the above on the national and international scales, according to the claim of the present invention, the present invention creates an extremely large system of appropriately linking individual unique identification headers relating to hundreds of thousands of physicians, individual unique identification headers relating to hundreds of millions of patients and immense uses of time and dates header representing diverse time and dates to extremely immense number of electronic files on said patients each of which comprises health and medical information and data on a patient.

In summary, in said settings, said headers appropriately linking to relevant files serve to route or direct said files according to the claims of the present invention to achieve the goals of the present invention.

Although the preferred embodiments of this invention have been described, it will be appreciated by those skilled in the art that adaptations and variations may be made without departing from the spirit of the invention and the scope of the claims.

1. A method of directing electronic files comprising health and medical information on a patient produced by physicians' spoken words representing said patient's information to specific sites within computers and servers in a network of computers and servers wherein said information are continually processed, sorted and recorded for continually accumulating health and medical information on said patient comprises:
a process of using an identification header relating to each physician in a voice recorder;
a process of using an identification header relating to each physician in a computer;
a process of using an identification header relating to each physician in a network of computers;
a process of using an identification header relating to each patient in a voice recorder;
a process of using an identification header relating to each patient in a computer;
a process of using an identification header relating to each patient in a network of computers;
a process of using time and dates header; and
a process of using a plurality of titles relating to health and medicine.

2. A system of linking individual identification headers relating to individual physicians, an identification header relating to a patient and time and dates header to electronic files each of which comprises a plurality of titles relating to health and medical information on said patient wherein said files are produced by said physicians' spoken words in diverse settings and places at diverse time and dates for routing said files to certain electronic sites within computers and servers in a network of computers and servers wherein each said file is processed as voice file and/or into text file and said information in each said file are continually sorted and recorded for continually accumulating said information on said patient comprises:
a process of assigning an identification of each physician to a computer memory;
a process of assigning an identification of each physician to a digital voice recorder;
a process of applying an identification of each physician in a digital voice recorder;
a process of applying an identification of each physician in a computer;
a process of using an identification header relating to each physician;
a process of using an identification header relating to each patient;
a process of transferring an identification header relating to each patient from a computer to a digital voice recorder;
a process of transferring individual identification headers relating to patients from a computer to a digital voice recorder;
a process of transferring an identification header relating to each physician from a computer to a digital voice recorder;
a process of transferring individual identification headers relating to physicians from computers to digital voice recorders;
electronic files each of which comprises a plurality of titles relating to health and medical information on said patient;
a process of linking individual identification headers relating to individual physicians to electronic files;
a process of linking an identification header relating to a patient to electronic files; and
a process of linking time and date headers to electronic files.

3. A system of appropriately linking thousands of individual identification headers relating to thousands of individual physicians, millions of individual identification headers relating to millions of patients and time and dates header to relevant electronic files each of which comprises a plurality of titles relating to health and medical information on a patient wherein said files are produced by said physicians' spoken words in diverse settings and places at diverse time and dates for routing said files to certain electronic sites within computers in a network of computers wherein each said file is processed as voice file and/or into text file and said information in each said file are continually sorted and recorded for continually accumulating said information on each said patient of said patients comprises:
a process of using individual identification headers relating to individual physicians in a voice recorder;
a process of using individual identification headers relating to individual physicians in a computer;
a process of using individual identification headers relating to individual physicians in a network of computers;
a process of using individual identification headers relating to individual patients in a voice recorder;
a process of using individual identification headers relating to individual patients in a computer;
a process of using individual identification headers relating to individual patients in a network of computers;
a process of using time and dates header; and
a process of using computer files each of which comprises a plurality of titles relating to health and medicine.
